(19) United States
(12) Patent Application Publication
(10) Pub. No.: US 2011/0244890 A1
(43) Pub. Date: Oct. 6, 2011

(54) METHOD AND APPARATUS FOR DETERMINING AND RECORDING OPERATOR'S USE OF A COMMUNICATION DEVICE WHILE OPERATING A VEHICLE

(76) Inventors: Harry V. Lehmann, Novato, CA (US); Michael L. Kelly, El Segundo, CA (US)

(21) Appl. No.: 13/079,638

(22) Filed: Apr. 4, 2011

Related U.S. Application Data
(60) Provisional application No. 61/320,468, filed on Apr. 2, 2010.

(51) Int. Cl. H04W 4/04

(52) U.S. Cl. 455/456.4

(57) ABSTRACT

To enable enforcement and monitoring of safety regulations, a system records events of broadcast communications from a driver's or machine operator's mobile communication device. The events may be annotated with other fact or circumstances, such as time, duration, speed of vehicle, motion of vehicle, type of communication, or mode of communication. The event may be determined through use of direction receive only antennas capable of receiving only those signals aligned with the antenna, signals not aligned with the direction of the antenna are not received and thus do not create a recordable event. The recorded event may be broadcast to an organization or person in real time or may be retrieved periodically. The event may also produce an alert for persons or other operators proximate the vehicle or machine.

### CROSS REFERENCES

This application is a non-provisional application claiming priority of co-pending provisional application: application Ser. No. 61/320,468 entitled Directional and Dielectric Caged Directional Received-Only Cellular Telephone Antenna Coupled with Time-Signatured Repeater Station for Monitoring Cellular Text or Vice Communication by Vehicle Operators filed Apr. 2, 2010;. The entirety of the referenced provisional application is incorporated herein by reference.

### BACKGROUND

The risks to road safety associated with Drivers' or Operators' engagement in text messaging and/or cellular voice communication is well understood, as recognized by the Legislatures of many States, and as recognized by regulatory agencies charged with the regulation of common carriers and other commercial carriers for safety purposes. So many examples of tragic consequences of driver/operator inattention abound that the inventor is plagued not by a rarity of exemplar, but by a flood. For context pertaining to the Disclosed subject matter hereby filed, only a few examples will be cited out of the flood of data supporting the point that driver/operators distracted by text messaging present a risk to themselves and others on the road.

While young drivers, sought to be regulated in their conduct by parents and guardians are an intended application of the disclosed subject matter here filed. In particular example, on Sep. 12,2008, in Los Angeles California, a severe train accident occurred as a result of the inattention of the train operator who had been engaged in text messaging with the teen train enthusiast within approximately one minute before the crash; the context of the exchanged messages, as widely reported, are consistent with the conclusion that the messaging was still closing between the two communicants when the wreck occurred. The post-crash investigation found that “it was a Metrolink engineer that failed to stop at a red signal” which was the “probable cause” of the ensuing disaster. The Metrolink, train collided with a freight train on an intersecting track. and would clearly have been avoided had the engineer been watching his job instead of engaging in text messaging to the young train enthusiast.

In the common carrier and freight context, this and similar events and concerns have resulted in regulatory steps. Most recently. as announced on Mar. 30, 2010. The United States Transportation Department proposed to make permanent a ban on text messaging while driving interstate commercial trucks and buses, following up on its call to reduce distractions that lead to crashes, as reported by the New York Times on March 31, 2010. Thus, both the need and the remedy have been acknowledged by the federal government of the United States.

The call for containment of the menace to safety presented by text-messaging and cell-calling drivers has also been recognized by many State governments, such as the Text Messaging Law which became effective in California on Jan. 1, 2009 which prohibits text messaging while driving, and which in turn follow up upon the California law prohibiting cellular telephone use while driving, which took effect on Jul. 1, 2008. Thus, laws are in place and further are sought to be put in place, in order to protect the public against the extreme dangers presented by drivers engaging in text messaging and/or handheld cellular device use while also engaged in driving a vehicle.

The problem that remains is that of verification and accountability. Parents cannot be with their teenage drivers on each and every trip. Police and transportation officials cannot “ride shotgun” with every commercial vehicle operator, whether rail or road. Yet, public safety will be greatly enhanced by the provision of a tool, such as by the disclosed subject matter, through which parents, employers, and governmental entities can decisively account for instances of handheld cellular telephonic communication by drivers, whether text or voice.

Solution for the need of those in governance and/or responsibility to track the use of hand held communications devices requires that several obstacles be overcome, amongst them; the emergency utility of the handheld device should not be impaired, the telecommunications signal should not be indiscriminately blocked, and a resulting Disclosed subject matter should not itself constitute a further distraction; while it is possible for the device to be telephone number specific, such an approach may be circumvented by the simple wile of a borrowed or secretly stowed cell phone. Yet, if the intended Method and Device be frequency-range specific, then the problem of use-warning being set off by other devices in the vehicle must also be addressed. The disclosed subject matter solves these problem areas and provides reliable driver-specific accountability for cellular device use while driving.

In order to obviate the deficiencies in the prior art and enhance safety it is an object of the disclose subject matter to present a novel method for determining when an operator of a vehicle is engaged in communication over a wireless device during operation of the vehicle. The method includes defining a signal reception zone which allows signals emanating from the wireless device in proximate to the operator and shielding those outside of the reception zone. The method further includes detecting a signal from the wireless at the receiver and creating an event based on the detected signal, the event which includes at least an indication a received signal and an associated time stamp is then stored in a memory and/or transmitted to an external entity. Thereby enabling enforcement of safety laws or rules regarding the use of wireless devices during vehicle operation.

It is also an object of the disclose subject matter to novel system for an operator controlled vehicle. The system includes, a receive only directional antenna; a shield isolating radio waves not emanating from or through a target area from being received by the directional antenna and allowing radio wave emanating from a target area to be received by the directional antenna. The system further comprises a processor for monitoring receipt of a signal at the direction antenna and determining an event based on at least if a signal is received and a memory connected to the processor, the processor causing the storage of the event in said memory.

These and many other objects and advantages of the present subject matter will be readily apparent to one skilled in the art to which the invention pertains from a perusal of the claims, the appended drawings, and the following detailed description of preferred embodiments.

### BRIEF DESCRIPTION OF THE DRAWINGS

FIG. 1 illustrates a cellular telephone reception antenna according to an embodiment of the disclosed subject matter.

FIG. 2 illustrates a dielectric-caged cellular frequency tuned antenna according to an embodiment of the disclosed subject matter.

FIG. 3 illustrates a dielectric-caged cellular frequency tuned antenna as connected with a GPS unit according to an embodiment of the disclosed subject matter.

FIG. 4 illustrates a dielectric-caged cellular frequency tuned antenna as connected with the ignition system of the subject vehicle according to an embodiment of the disclosed subject matter.

FIG. 5 illustrates a dielectric-caged cellular frequency-tuned antenna as connected to a switch according to an embodiment of the disclosed subject matter.

FIG. 6 illustrates the dielectric walls of the containment shield may be narrowed according to an embodiment of the disclosed subject matter.

FIG. 7 illustrates multiple receive only directional antennas for eliminating false positive events according to an embodiment of the disclosed subject matter.

### DESCRIPTION

The Disclosed subject matter here claimed is for a “ caged,” or “shielded” receive-only radio wave antenna which is coupled with, at the option of the manufacturer and/or the end user. a signal repeating or recordation station, which, through linkage to a GPS unit or accelerometer, provides a time signature record of the fact of cellular text or voice communication by a vehicle operator. The resulting message signal or record will thereby inform the vehicle owner, be it parent or corporate or governmental interest, with notification of the fact of cellular device use by the operator or driver of the subject vehicle involved, whether road. rail, or air. The claims asserted below are asserted for all manner of radio transceiver devices˜including but not limited to the cellular telephone frequencies commonly used in the United States, between 824 MHz and 894 :MHz.

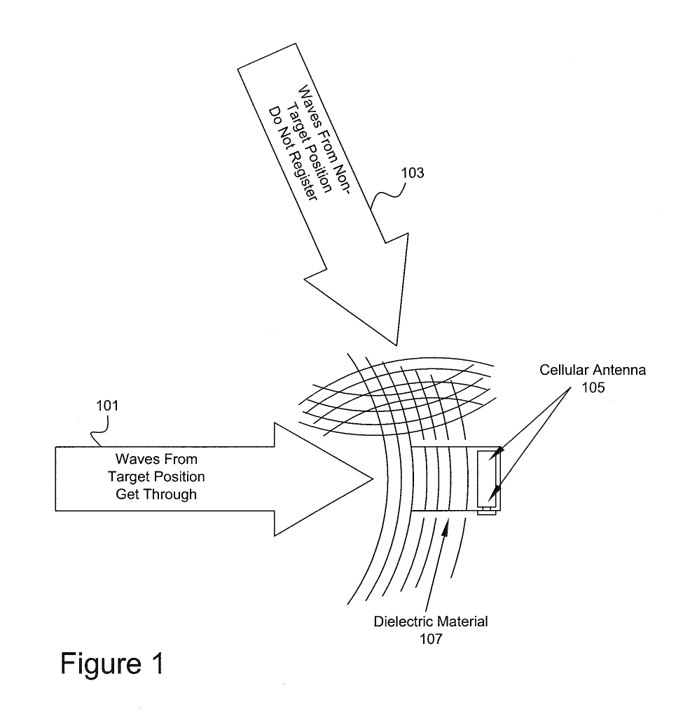

FIG. 1 shows a cellular telephone reception antenna unit 105, caged at the end of a tube of dialectic (signal blocking) material 107, receptive to the range of transmission frequencies commonly associated with cellular devices, so that, as a result of such limited dielectric confinement, the cellular frequency involved is only received in a directional manner. Other shielding and wave guides may also be advantageously used to form the directional reception antenna unit 105. Thus because of the shielding , the unit 105 will only register cellular frequency signal receipt when the signal is coming from a particular direction. As will be illustrated in ensuring Figures, this development allows the isolation of signal receipt to those signals originating from a particular, manufacturer adjustable, angle and direction, and, by the dielectric barrier, rules out from registry by the antenna 105, frequency broadcasts which do not originate from the target area upon which the unit (comprised of the antenna and the shielding) is focused. The effect of this arrangement as illustrated in FIG. 1 allows receipt of the handheld cellular broadcast signal only from the designated or target area within the vehicle, such as the seating area of the vehicle operator and appropriate surrounds. The disclosed subject matter, as composed of such tuned antenna and such dielectric partial cage, or shielding as may be constructed through the use of any dielectric material, conductive material whether solid, or in the alternative through the plating or spray application of dielectric material (such as, for example, ferrite particles or nano particles) on less expensive core materials. As shown in FIG. 1 those Waver 103 from a non target position are not received at the antenna 105, whereas the waves 101 from the target position are received by the antenna 105.

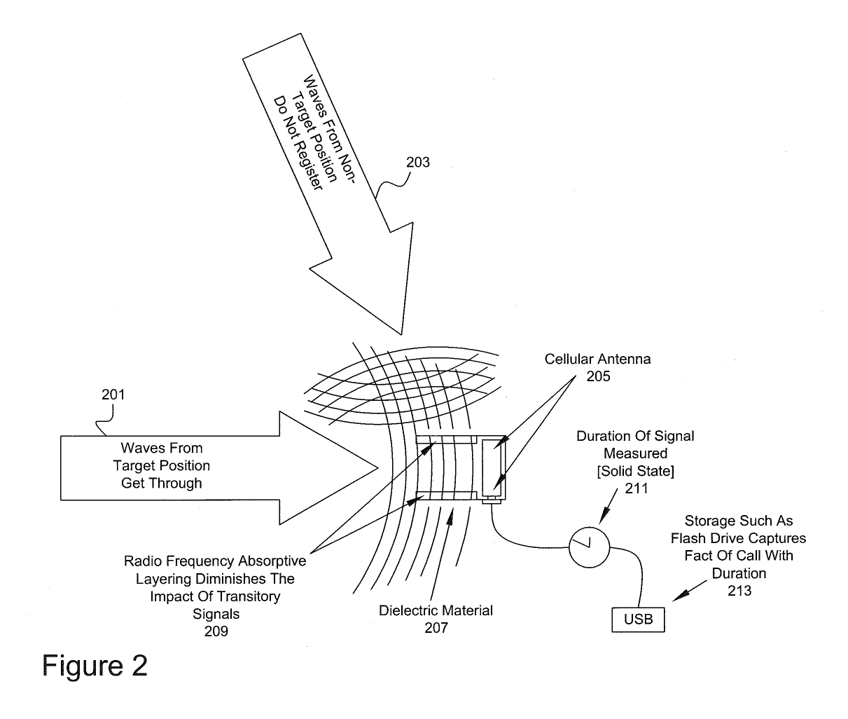

FIG. 2 Shows the dielectric-caged or similarly shielded cellular frequency tuned antenna 205 as connected to a time measurement based switch such that, upon the closure of the switch, as occurring in response to cellular broadcast frequency receipt for a manufacturer programmable time increment, a time registry device 211 is actuated, which in turn, causes an electronically time stamped message (i.e., “cellular device actuated by driver”) to be imbedded upon a recording device such as a portable digital data storage device 213, which may be deployed and secured so that only the vehicle owner or agency can access said device. This then involves two levels of time registry the first switch receives, via the antenna, the cellular broadcast signal and after a manufacturer definable (or end user definable) period of seconds (so as to avoid false positives from transient signals) will close the switch, in turn starting the process of data registry to solid state chip, which notes and stores the fact of the cellular use by the driver, and the duration of that use. FIG. 2 Additionally shows the installation of a layer of microwave absorptive materials including for example a mixture containing ferrite powder(such as in expired U.S. Pat. No. 3,754,255 and in many later patents, both expired and active); so as to reduce false positive report from transient signal refection. Again the shielding of the antenna from waves 203 from non targeted positions may be from the dielectric material 207, radio frequency absorptive layers 209 or by manner of reflecting the non-targeted waves 203. The shielding allows only the waves 201 from the target position to be received by the antenna 205.

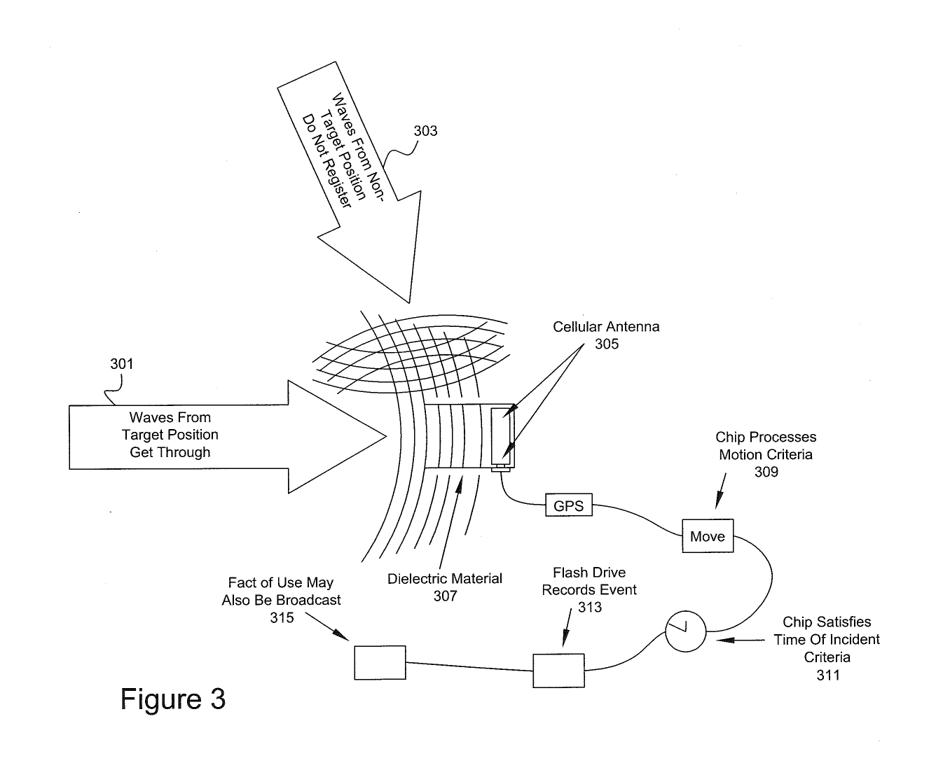

FIG. 3 Shows the dielectric-caged cellular frequency tuned antenna as connected with a GPS unit, so that should a manufacturer so desire, the disclosed subject matter may be to actuated when, via GPS measurements or from other translation derivable sensors, it is ascertainable that the vehicle involved is moving, or engaged in a pattern or characteristic consistent with driving. Other sensors may include but not limited to accelerometers and gyroscopic methods of motion detection. The movement may also be filtered or analyzed for certain criteria by processor 309, and/or by duration by timer 311. The movement and event of broadcasting may be recorded in Flash Drive 313 and the recorded information may be broadcast over a transmit radio 315. Again as shown in FIG. 3, the waves 303 from a non targeted position are shielded from registering on the antenna 305 and thus will not result in a record of cellular use, whereas the waves 301 from the target position with be recorded in the storage 313 and may be broadcast from the transmitter 315. The use of motion detection allows the driver to engage in communications while not actually driving, such as when pulled over along the side the road, or parked.

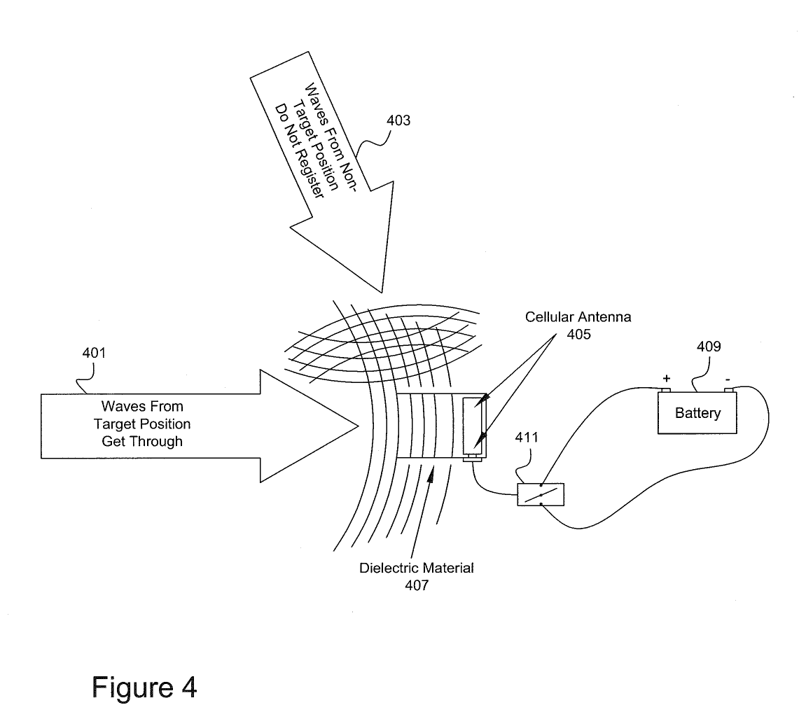

FIG. 4 shows the dielectric-caged cellular frequency tuned antenna 405 as connected with the ignition system (starter switch 411 and battery 409) of the subject vehicle, so that, should a manufacturer so desire, the detection and recording of broadcast waves 401 from the target area may be tuned at discretion to actuate only when the subject vehicle is in the “on” position, thereby allowing cellular telephone contact by the driver without registry of the fact of such contact when the vehicle is in the stationary and “off,” condition. The waves 403 are shielded from reception at the antenna by dielectric material 407 or other directional shielding method or apparatus.

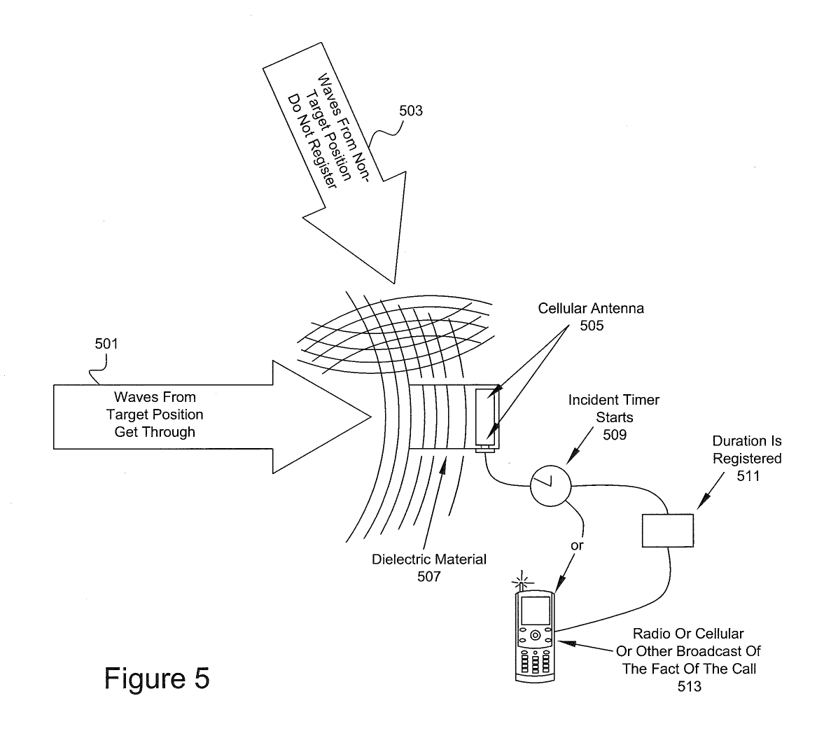

FIG. 5 shows the dielectric-caged cellular frequency-tuned antenna 505 as connected to a timer switch 509, such that, upon cellular device use resulting in waves 501 from the target zone monitored by the cone of perception of the shielded antenna 505, and satisfying some duration or motion criteria as the manufacturer may desire as set forth in FIG. 2, above, the event and duration may be register in register 511, or through a broadcast radio means 513, including but not limited to a cellular device broadcasting a text message, to inform the parent, or vehicle owner or regulatory agency, of the fact of such cellular device use by the operator of the vehicle involved. In the broadcast by include an alert to drivers in immediate proximity to the vehicle. The waves 503 are shielded from reception at the antenna by dielectric material 507 or other directional shielding method or apparatus.

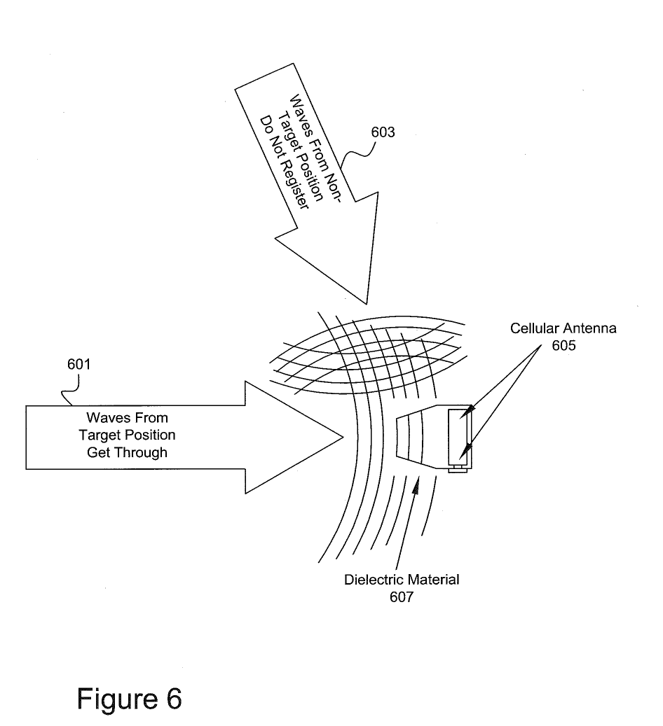

FIG. 6 Shows that the dielectric walls of the containment cage may be narrowed example to a pyramidal or conical shape providing an additional mechanism for narrowing the scope from which cellular broadcast may be received, for precision in defining the anticipated physical position of the vehicle operator, with the additional benefit that the height of the containment cage may be thereby reduced, as an aid to placement, whether concealed or not. Since the narrowing of the dielectric cage deflects (in this instance away from the receive-only antenna), and as it is noted that cellular towers are neither directly above nor below a vehicle, the conical variant will particularly in the overhead configuration, have some effect in assisting cellular signal reception in low signal areas. A wave guide may also be beneficially used in the roof guide to assist the acquisition of the waves 601 from the target area.

Through the installation of the Disclosed subject matter, as described above, including but not limited to as described in the foregoing Figures, the parent or vehicle owner, or regulatory entity (including through “black box” recording) can be made aware, either after the fact, or, if so made such as per FIG. 5, above, immediately, of each instance of use by the driver of the subject vehicle of any cellular communication device. While the claims hereof have been articulated pertaining to cellular devices and frequencies, each and all the same Claims are asserted for all manner of handheld radio devices, including those operating at wave lengths different from the standard wavelengths currently authorized for cellular device transmission. While the Disclosed subject matter has been illustrated with side view, which may be seen as involving rectangular, and, if tapering, pyramidal shape, the Disclosed subject matter is readily subject to a cylindrical iteration˜including with a circular backing, as is commonly deployed in the fabrication of directional antennas, and as would accommodate the many cellular antennas which are available in a circular shape.

The use of smaller antenna will result in dimensional diminishment in all aspects, with resulting enhancement in placement alternatives. Additionally, while antenna already in the market bearing the capacity and circuitry for receipt and transmission of signal may be employed as the antenna module for the Disclosed subject matter as herein filed, a “receive only” antenna will avenues for greater miniaturization and given the short range inherently involved in practical application of the receive-only structures of reduced material thickness and size may be used to facilitate further miniaturization, within limitations inherent in the wave lengths involved.

The Disclosed subject matter herein filed may be installed wherever in the subject vehicle the owner and/or manufacturer may prefer. Close installation to the targeted position of anticipated signal may reduce false positive from transient signal, as will length of dielectric tube in relation to antenna size. The time increment condition prior to initiation of authentication routines will also reduce the incidence of false positive signal, as will calibrated reduction in antenna sensitivity, which may be affected, for example, by signal dampening structure or layer. The disclosed subject matter need not issue material electromagnetic signal near the point of signal reception by the receive-only antenna, and installations in the steering wheel, or above and behind the operator's position, and beneath the driver's seat are noted as potential efficient placements for the caged antenna, whereas other aspects of the Disclosed subject matter can be more remotely housed, including in tamper resistant stitching. It is noted that the Disclosed subject matter, being a receive only” device (at least as to the dielectric caged cellular telephone tuned antenna, and in all applications not involving an immediate broadcast out signal) does not of itself involve any broadcast of microwave or other communicational energies, and; therefore, there is no health risk associated with the placement of the receive only aspects of the device at any level of proximity to the driver or other occupants. Installation along the longitudinal axis of the vehicle, with slope, is noted as likely to reduce false positive reading from cellular broadcast from positions other than that of the operator.

An aspect of the disclosed subject matter is the ability to discern between text and voice messages and record the type of communication.

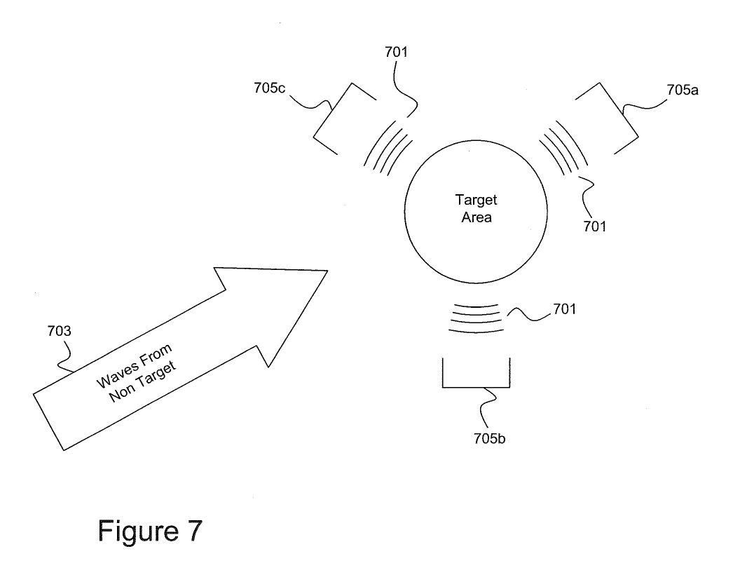

Another aspect of the disclosed subject matter is the use of multiple directionally shielded receive only antennas, by with non-targeted broadcasts may be more readily distinguished. FIG. 7 shows an embodiment with multiple shielded antennas. The target area is surrounded by three shielded antennas 705a-c, each antenna is capable receiving signals 701 emanating from target area, whereas signals 703 coming from outside the target area may only be received by one or at most two of the three antennas, thus providing a further means to avoid false positive and only record actual occurrences of communications by the driver.

Still another aspect of the disclosed subject matter is the ability to transmit the information in real time to law enforcement or other agencies, or provide a visual alert to other drivers that the vehicle operator is likely distracted. Such a visual alert may be in the form of flashing lights (brake lights, blinkers, hazards, headlights, running lights) or other non disruptive signal.

Yet another aspect of the disclosed subject matter is the ability to discern between control signals and communication signals broadcasting from the target area. Most modern mobile devices may constantly broadcast control and update information over a control channel in order to update network operations as to its location and accessibility. This control communication takes place even if no communication event is occurring and thus this event would be advantageously recorded with a notation that is was a control signal, or such control broadcast may be advantageously ignored and not recorded as an event.

Still yet another aspect of the disclosed subject matter is filtering based on received power. Filtering based on receive power may greatly assist the discrimination of waves from the non-targeted areas. Because of the proximity of the antenna to the target area, broadcasts emanating from mobile devices will have a much higher power level vs signals emanating for outside the target area. Thus even signals that are received by the receive only antenna may be dismissed if not above a power level threshold.

The disclosed subject matter records events of broadcast communications from a driver's or machine operator's mobile communication device. The events may annotated with other fact or circumstances, such as time, duration, speed of vehicle, motion of vehicle, type of communication, or mode of communication. The event may be determined as described above through use of direction receive only antennas capable of receiving only those signals aligned with the antenna, signals not aligned with the direction of the antenna are not received and thus do not create a recordable event. The events may be recorded in any number of methods and apparatus include ram, flash drives, USB drive, hard drives, optical disks and drives, magnetic tape, etc. Additionally, it may be advantageous to hide the antenna and recording apparatus.

Mobile devices, cellular phone, phone, communication device and mobile appliance have been used interchangeable throughout the specification. A distinction between terms above absent regard to the context of such use should not be implied, as these terms are directed to mobile wireless communication device however so labeled.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. A system for an operator controlled vehicle comprising:
a receive only directional antenna;
a shield isolating radio waves not emanating from or through a target area from being received by the directional antenna; said shield allowing radio wave emanating from a target area to be received by the directional antenna;
a processor operably connected to the directional antenna for monitoring receipt of a signal at the direction antenna and determining an event based on at least if a signal is received;
a memory operably connected to the processor, said processor causing the storage of the event in said memory;
wherein said target area comprises the area proximate to the operator while in control of the vehicle.

2. The system of claim 1, wherein the shield comprises a dielectric cage.

3. The system of claim 1, wherein the shield comprises radio wave absorption material.

4. The system of claim 1, wherein the shield comprises a radio wave reflective material.

5. The system of claim 1, wherein the directional antenna is positioned in the roof of the vehicle and directed towards the target area.

6. The system of claim 1, further comprising a transmitter operably connected and controlled by the processor, wherein the transmitter broadcasts the event to an external receiver.

7. The system of claim 1, wherein the memory is selected from the group consisting of a hard disk, optical disk, flash drive, tape, floppy disk, and thumb drive.

8. The system of claim 1, further comprising a motion detector, wherein said motion detector provide information to the processor regarding the kinetics of the vehicle, and wherein said processor further determines the event based on the information from the motion detector.

9. The system of claim 8, wherein the motion detector comprises a GPS or an accelerometer.

10. The system of claim 6, wherein said external receiver comprises a mobile phone.

11. The system of claim 1, further comprising an alert signal observable from outside the vehicle, wherein said processor causes the alert signal to be engaged on occurrence of the event.

12. The system of claim 1, wherein the shield is conically shaped.

13. The system of claim 1, further comprising a timing device, said timing device recording the duration of the event.

14. The system of claim 1, further comprising a ignition indicator, said indicator signaling the processor when the vehicle is turned on, and said processor further determines the event based on the signaling.

15. The system of claim 1, further comprising a second directional antenna and a second shield isolating radio waves not emanating from or through a target area from being received by the second directional antenna; said second shield allowing radio wave emanating from a target area to be received by the directional antenna, and wherein said processor further determines the event based on if a signal is received at the second directional antenna.

16. The system of claim 1, wherein the processor analyses the received signal an further determines the event based on the analysis.

17. The system of claim 16, wherein the analysis determines whether the signal is a text or voice communication, or whether the signal is a traffic signal or control signal.

18. A method for determining if an operator of a vehicle is communication over a wireless device during operation of the vehicle, comprising
defining a signal reception zone, said zone allowing signals emanating from the wireless device in a target area proximate to the operator
shielding a receiver from radio signals outside of the reception zone;
detecting a signal from the wireless at the receiver creating an event based at least on the detected signal, said event comprising at least an indication a signal was detected and an associated time stamp;
storing the event in a memory.

19. The method of claim 18, further comprising transmitting the stored event to an external receiver.

20. The method of claim 18 wherein the step of creating an event further comprising the steps of determining the characteristics of the received signal, the kinetic status of the vehicle and the duration of the signal.
